(19) United States
(12) Patent Application Publication
(10) Pub. No.: US 2025/0337125 A1
(43) Pub. Date: Oct. 30, 2025

(54) Power Battery System for a Vehicle and Thermal Assessment Method

(71) Applicant: Mercedes-Benz Group AG, Stuttgart (DE)

(72) Inventors: Haocheng SUN, Beijing (CN); Yufei JIANG, Beijing (CN); Tao HU, Beijing (CN); Haijing DONG, Beijing (CN)

(21) Appl. No.: 18/868,633

(22) PCT Filed: May 25, 2023
(86) PCT No.: PCT/CN2023/096194

§ 371 Date: Nov. 22, 2024

(30) Foreign Application Priority Data
May 30, 2022 (CN) 202210599768.X

(51) Int. Cl. H01M 50/507; H01M 10/658; H01M 50/249; H01M 50/30; H01M 50/519; H01M 50/522

(52) U.S. Cl. CPC H01M 50/507; H01M 10/658; H01M 50/249; H01M 50/30; H01M 50/519; H01M 50/522; H01M 2200/10; H01M 2200/20

(57) ABSTRACT

Please substitute the new Abstract submitted herewith for the original Abstract:

A power battery system of a vehicle includes a battery module which at least has a plurality of battery cells and a plurality of busbar assemblies. The busbar assemblies are configured to connect adjacent battery cells. The busbar assembly has a busbar which is connected to the battery cells, a flexible circuit board which is integrated with a temperature sensor and outputs a temperature signal, an inner heat shield insulating layer which is disposed at least between the busbar and the flexible circuit board, an outer insulating layer which is configured to wrap the busbar and the flexible circuit board, and a controller which is configured to receive a temperature signal detected by the temperature sensor of each of the busbar assemblies and to predict a direction of thermal diffusion and/or a breakdown point of the battery module according to the temperature signals.

### BACKGROUND AND SUMMARY OF THE INVENTION

The present disclosure relates to the field of batteries, in particular to a power battery system for a vehicle. The disclosure further relates to a thermal assessment method for a power battery system of a vehicle.

In recent years, electric vehicles or hybrid vehicles powered by power batteries have received more and more attention because of many advantages such as zero emission, high efficiency, etc., and the safety issue of power batteries is in particular a focus of research.

For power batteries, there are various causes that may trigger thermal runaway accidents, such as the impact or extrusion caused by a collision, overcharging or overdischarging, improper temperature management, etc., and these triggering causes are correlative with one another, resulting in a thermal runaway of a positive feedback loop. When a thermal runaway occurs in a battery cell of the power battery, the battery cell is in a state of thermal runaway and emits a large amount of heat, and consequently the temperature rises sharply, even exceeding 1000° C. In this case, the battery cell material and the busbar may melt and burn and an insulation failure may occur, leading to deformation of the busbar and a short circuit, which further exacerbates the thermal runaway and then develops into thermal diffusion that spreads the heat further to the surrounding battery cells and causes thermal runaway of other battery cells. In addition, the insulating material used for the busbar is burned in the thermal runaway state, leaving the busbar exposed to the power battery, where the high-temperature gas and erupting materials may cause electrical arcs in the copper busbar and the power battery case, which will break down the battery case and eventually lead to burning of the entire power battery or even explosion.

At present, in the event of a thermal runaway of the power battery, the prior art can only issue a notice warning the occurrence of thermal diffusion, but cannot assess the situation of the thermal diffusion of the power battery, in particular the direction of thermal diffusion and the breakdown point. This is disadvantageous to the failure cause analysis and it brings potential risks to the follow-up rescue.

Therefore, an object of the present disclosure is to propose an improved power battery system for a vehicle, which power battery system can accurately predict a direction of thermal diffusion and/or a breakdown point of a battery module according to multiple temperature signals in the battery module in the event of a thermal runaway of battery cells of the battery module, thereby determining a degree of thermal diffusion and providing a basis for failure cause analysis and effectively improving the safety of the rescue work.

According to a first aspect of the disclosure, a power battery system for a vehicle is proposed, wherein the power battery system at least comprises:
a battery module, which at least comprises a plurality of battery cells and a plurality of busbar assemblies, the busbar assemblies are configured to connect the adjacent battery cells, wherein the busbar assembly at least comprises: a busbar, which is connected to the battery cells; a flexible circuit board, which is integrated with a temperature sensor and outputs a temperature signal detected by the temperature sensor; an inner heat shield insulating layer, which is arranged at least between the busbar and the flexible circuit board; and an outer insulating layer, which is configured to wrap the busbar and the flexible circuit board; and
a controller, which is configured to receive a temperature signal detected by the temperature sensor of each of the busbar assemblies and to predict a direction of thermal diffusion and/or a breakdown point of the battery module according to the temperature signals.

According to the present disclosure, the power battery system is provided with temperature sensors in the plurality of busbar assemblies of the battery module, and the temperature sensors can detect the temperature at each of the busbars, so that in the event of a thermal runaway of the battery module, the temperatures at multiple positions in the battery module can be acquired according to the temperature signals detected by the temperature sensors, thereby obtaining a temperature distribution and predicting a direction of thermal diffusion and/or breakdown point in the battery module, in order to advantageously assess a degree of thermal diffusion and improve the safety of the rescue work. In addition, the inner heat shield insulating layer arranged between the busbar and the flexible circuit board can weaken the adverse effect of the busbar heated at high temperature on other components, in particular on the flexible circuit board, and slow down the speed of thermal diffusion.

According to an exemplary embodiment of the disclosure, the controller is arranged in a battery management system or a body control unit of the vehicle, or in a remote server for the vehicle.

According to an exemplary embodiment of the disclosure, at least one of the busbar assemblies further comprises an air pressure sensor, which comes into contact with gas in the battery module through an opening in the outer insulating layer and outputs an air pressure signal via the flexible circuit board.

According to an exemplary embodiment of the disclosure, the controller assesses a degree of thermal diffusion of the battery module and/or an opening state of a pressure relief valve for the battery module according to the air pressure signal.

According to an exemplary embodiment of the disclosure, the inner heat shield insulating layer is arranged in the form of a layer between the busbar and the flexible circuit board; or the inner heat shield insulating layer wraps the busbar in the form of a sheath.

According to an exemplary embodiment of the disclosure, the outer insulating layer is integrally constructed, in particular as a heat shrinkable sleeve; or the outer insulating layer is constructed as a first outer insulating layer and a second outer insulating layer separated from each other, wherein the first outer insulating layer and the second outer insulating layer are fixedly connected to each other in a form-fit manner.

According to an exemplary embodiment of the disclosure, the outer insulating layer is made of a heat-resistant and fire-resistant material, in particular made of polyphenylene sulfide; and/or the busbar assembly further comprises an additional heat insulating layer arranged between the outer insulating layer and the flexible circuit board and/or between the outer insulating layer and the busbar; and/or the busbar is made of copper, aluminum, nickel or an alloy thereof.

According to an exemplary embodiment of the disclosure, the power battery system further comprises an interaction unit, which displays a temperature distribution inside the battery module in the form of an image and feeds back the direction of thermal diffusion and/or the breakdown point of the battery module predicted by the controller.

According to an exemplary embodiment of the disclosure, the controller sends the temperature signals or the direction of thermal diffusion and/or the breakdown point predicted based on the temperature signals to an original equipment manufacturer of the vehicle via a real-time monitoring system of the vehicle.

According to a second aspect of the disclosure, a thermal assessment method for a power battery system of a vehicle is proposed, characterized in that the thermal assessment method at least comprises the following steps:
S1: detecting temperature signals of a plurality of busbar assemblies of a battery module of the power battery system;
S2: determining that the battery module is in a thermal runaway state, if the temperature signal of at least one of the busbar assemblies exceeds a temperature threshold; and
S3: predicting a direction of thermal diffusion and/or a breakdown point of the battery module based on the temperature signals of the busbar assemblies.

The principles, characteristics and advantages of the present disclosure can be better understood by describing the disclosure in more detail with reference to the accompanying drawings.

### BRIEF DESCRIPTION OF THE DRAWINGS

FIG. 1 shows a schematic block diagram of a power battery system for a vehicle according to an exemplary embodiment of the disclosure;

FIG. 2 shows a schematic view of a busbar assembly for a power battery system of a vehicle according to an exemplary embodiment of the disclosure;

FIG. 3 shows a schematic view of a busbar assembly for a power battery system of a vehicle according to another exemplary embodiment of the disclosure; and

FIG. 4 shows a schematic flowchart of a thermal assessment method for a power battery system of a vehicle according to an exemplary embodiment of the disclosure.

### DETAILED DESCRIPTION OF THE DRAWINGS

For a clearer understanding of the technical problem to be solved, technical solutions and advantageous technical effects of the present disclosure, the disclosure will be further elaborated in conjunction with the drawings and a number of exemplary embodiments. It is to be understood that the specific embodiments described here are only for the purpose of explaining the disclosure, but not for limiting the scope of the disclosure.

In the description of the embodiments, directional or positional relationships such as “above”, “below” are based on the directional or positional relationships shown in the drawings, which are only for the convenience of describing and simplifying operations, rather than specifying or implying that the device or element being referred to must be in a specific orientation, or be constructed and operated in a specific orientation, and therefore should not be construed as limitations on the disclosure.

In this specification, unless otherwise specified and limited, the terms “install”, “link” and “connect” should be interpreted in a broad sense. For example, it may refer to a fixed connection, a detachable connection, or an integrated connection; it may refer to a mechanical connection or an electrical connection; and it may also be a direct connection, an indirect connection through an intermediate part, or an internal communication between two elements. Those of ordinary skill in the art can understand the meanings of the above terms in the context of the present disclosure according to the situation.

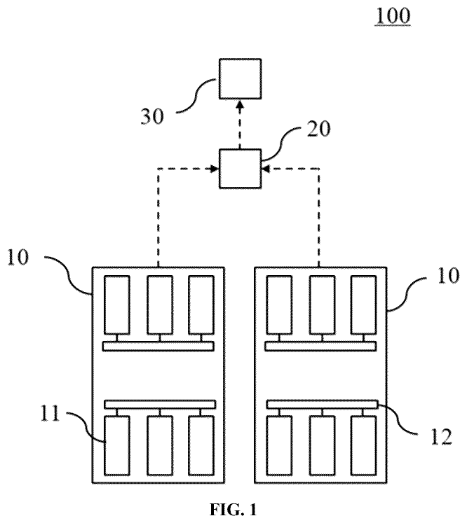

FIG. 1 shows a schematic block diagram of a power battery system 100 for a vehicle according to an exemplary embodiment of the disclosure. The vehicle here may be an electric vehicle or a hybrid vehicle.

As shown in FIG. 1, the power battery system 100 comprises a plurality of battery modules 10, which are jointly packaged into a battery pack, wherein each of the battery modules 10 comprises a plurality of battery cells 11 or single cells, and the battery cell is the smallest energy storage unit of the power battery system 100 and has a relatively high energy density, wherein the adjacent battery cells 11 are connected in series or in parallel by a busbar assembly 12, thereby gathering and collectively outputting currents of different battery cells 11, wherein the busbar assembly 12 is fixedly connected to a tab or post terminal of the battery cell 11, thereby leading the current of the battery cell 11 out.

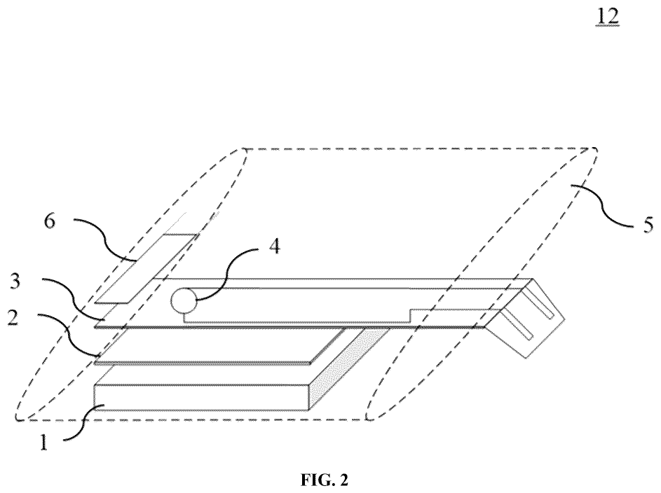

FIG. 2 shows a schematic view of a busbar assembly 12 for a power battery system 100 of a vehicle according to an exemplary embodiment of the disclosure.

As shown in FIG. 2, the busbar assembly 12 comprises a busbar 1, which is configured to be connected to a tab or post terminal of the battery cell 11 and lead the current of the battery cell 11 out. To this end, the busbar 1 should have good electrical conductivity and thermal stability. Here, the busbar 1 may be configured as a copper bar, which has the advantages of low electrical resistivity and good processability. However, it is also conceivable that the busbar 1 is made of other materials that are considered meaningful by those skilled in the art, for example, aluminum, nickel or an alloy thereof.

As shown in FIG. 2, the busbar assembly 12 further comprises an inner heat shield insulating layer 2, which is arranged directly against the busbar 1 and configured for preventing the heat and current of the busbar 1 from causing adverse effects on other components of the battery module 1, and which is also capable of avoiding short circuit that causes electrophoretic breakdown in the event of a thermal runaway. Here, the inner heat shield insulating layer 2 is made of heat-resistant and fire-resistant insulating materials, such as polyvinyl chloride, polyethylene naphthalate, polyphenylene sulfide, etc. added with flame retardant. Here, the inner heat shield insulating layer 2 is, for example, constructed in the form of a layer and rests against the busbar 1. However, it is also conceivable that the inner heat shield insulating layer 2 is constructed in the form of a sheath, a hollow sleeve or an adhesive tape and wraps around the entire busbar 1.

As shown in FIG. 2, the busbar assembly 12 further comprises a flexible circuit board 3, which is integrated with a temperature sensor 4 for detecting temperature and is printed with printed wiring, the printed wiring outputs the temperature signal detected by the temperature sensor 4 to the outside, wherein the temperature sensor 4 is, for example, designed as a thermocouple. Here, the flexible circuit board 3 is in communication connection with a battery management system for the power battery system 100, in particular via the printed wiring. Here, the inner heat shield insulating layer 2 is arranged between the busbar 1 and the flexible circuit board 3, thereby preventing the temperature and current of the busbar 1 from affecting the flexible circuit board 3. Here, compared with traditional wires, the flexible circuit board 3 can be more easily assembled with the busbar 1 and has higher thermal stability in the event of thermal runaway of the battery cell 11.

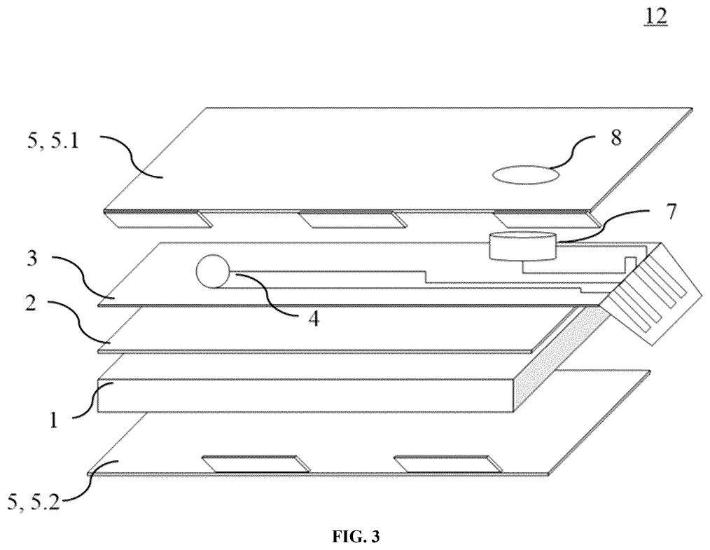

As shown in FIG. 2, the busbar assembly 12 further comprises an outer insulating layer 5, which is configured for wrapping other components of the busbar assembly 12, in particular the busbar 1 and the flexible circuit board 3. The outer insulating layer 5 can increase the overall insulation and wear resistance of the busbar assembly 12 and prevent short circuits and breakdown points as much as possible in the event of thermal runaway of the battery cell 11. Here, as an example, the outer insulating layer 5 is integrally configured in the form of a heat shrinkable sleeve, but other forms of configuration are also conceivable. See FIG. 3 for details. Here, the outer insulating layer 5 is made of an insulating material, such as polyethylene or polyvinyl chloride, etc., but it is also conceivable that the outer insulating layer 5 is made of a heat-resistant and fire-resistant insulating material, thereby further enhancing the heat and fire resistance of the busbar assembly 12 and slowing down the speed of heat diffusion in the event of a thermal runaway. Here, the color of the outer insulating layer 5 may be changed to meet the color requirements of the user for the busbar assembly 12.

Exemplarily, as shown in FIG. 2, the busbar assembly 12 further comprises an additional heat insulating layer 6 arranged between the outer insulating layer 5 and the flexible circuit board 3 and/or arranged between the outer insulating layer 5 and the busbar 1. The heat insulation capability of the busbar assembly 12 can be further improved and the speed of heat diffusion can be slowed down by the additional heat insulating layer 6. The additional heat insulating layer 6 is particularly suitable when the outer insulating layer 5 is made of an insulating material that is not resistant to high temperature. Here, the additional heat insulating layer 6 may wrap around the busbar 1 and the flexible circuit board 3 in the form of an adhesive tape or a sleeve.

FIG. 3 shows a schematic view of a busbar assembly 12 for a power battery system 100 of a vehicle according to another exemplary embodiment of the disclosure.

Different from the busbar assembly 12 shown in FIG. 2, the busbar assembly 12 shown in FIG. 3 further comprises an air pressure sensor 7, which comes into contact with gas in the battery module 10 through an opening 8 in the outer insulating layer 5 and is configured to detect an air pressure signal. The air pressure sensor 7 is, for example, integrated in the flexible circuit board 3, and the air pressure signal detected by the air pressure sensor 7 is output through the printed wiring of the flexible circuit board 3 to the outside.

As shown in FIG. 3, the outer insulating layer 5 of the busbar assembly 12 is constructed as a first outer insulating layer 5.1 and a second outer insulating layer 5.2 separated from each other, wherein the first outer insulating layer and the second outer insulating layer may be injection molded by an insulating material and be fixedly connected to each other in a form-fit manner, for example, by snap-fit connection or insertion connection.

As shown in FIG. 1, the power battery system 100 further comprises a controller 20, which receives the temperature signal detected by the temperature sensor 4 of each of the busbar assemblies 12 of the battery module 10 and the air pressure signal detected by the air pressure sensor 7. Here, the controller 20 acquires a temperature distribution inside the battery module 10 according to the temperature signals at the plurality of busbar assemblies 12 of the battery module 10. Here, when at least one of the temperature signals received by the controller 20 exceeds a preset temperature threshold, the controller 20 determines that the battery module 10 and the battery cell 11 associated with the temperature signal are in a thermal runaway state, where the temperature threshold is stored in the controller 20. Based on the multiple temperature signals from the busbar assemblies 12, the controller 20 predicts a direction of thermal diffusion of the battery module 10 starting from the battery cell 11 where the thermal runaway occurs, and further predicts a possible breakdown point in the battery module 10. Here, an algorithm for predicting the direction of thermal diffusion and/or the breakdown point of the battery module 10 may be stored in the controller 20.

Exemplarily, the controller 20 is directly integrated into a battery management system (BMS) of the vehicle, which system is configured to monitor a state of the power battery and intelligently manage and maintain each of the battery modules 10. Here, the flexible circuit board 3 of the busbar assembly 12 of the battery module 10 is electrically connected to the controller 20 arranged in the battery management system. Furthermore, it is also conceivable for the controller 20 to be arranged in a body control unit (BCU) of the vehicle or in a remote server for the vehicle, which remote server is provided, for example, in an original equipment manufacturer of the vehicle and is in communication connection with the battery management system via wireless communication technology.

Exemplarily, the controller 20 may assess a degree of thermal diffusion of the battery module 10 according to the air pressure signal detected by the air pressure sensor 7 of each of the busbar assemblies 12. A greater air pressure signal detected by the air pressure 7 indicates a larger amount of gas leaked from the battery cells 11 to the battery module 11, thereby indicating a higher degree of thermal diffusion of the battery module 10. In addition, the controller 20 may further assess an opening state of a pressure relief valve for the battery module 10 according to the air pressure signals, in particular an opening time and pressure relief effect of the pressure relief valve. Here, based on the multiple temperature signals and air pressure signals of the battery module 10, the controller 20 is allowed to more accurately assess the degree of thermal diffusion of the battery module 10 and predict the direction of thermal diffusion and/or the breakdown point of the battery module 10.

Exemplarily, as shown in FIG. 1, the power battery system 100 further comprises an interaction unit 30, which receives information from the controller 20, thereby displaying the temperature distribution inside the battery module 10 in the form of an image and feeding back the direction of thermal diffusion and/or the breakdown point of the battery module 10 predicted by the controller 20. In this way, relevant information can be provided to vehicle occupants and rescue workers in the event of a thermal runaway of the battery module 10, thereby assisting the vehicle occupants in making a right decision and improving the rescue efficiency.

Exemplarily, the controller 20 can send the temperature signals or the direction of thermal diffusion and/or the breakdown point predicted based on the temperature signals to an original equipment manufacturer of the vehicle via a real-time monitoring system of the vehicle, in order to speed up the failure cause analysis of the battery module 10 and call the rescue service in time.

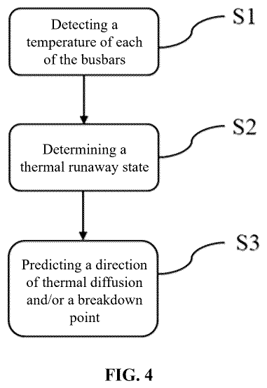

FIG. 4 shows a schematic flowchart of a thermal assessment method for a power battery system 100 of a vehicle according to an exemplary embodiment of the disclosure. The thermal assessment method is implemented by the power battery system 100 according to the present disclosure.

As shown in FIG. 4, the thermal assessment method comprises the following steps:
S1: detecting temperature signals of a plurality of busbar assemblies 12 of a battery module 10 of the power battery system 100;
S2: determining that the battery module 10 is in a thermal runaway state, if the temperature signal of at least one of the busbar assemblies 12 exceeds a temperature threshold; and
S3: predicting a direction of thermal diffusion and/or a breakdown point of the battery module 10 based on the temperature signals of the busbar assemblies 12.

The preceding explanation of the embodiments only describes the present disclosure within the framework of the examples described here. Of course, individual features of the embodiments can be freely combined with one another, as long as it is technically meaningful without departing from the scope of the disclosure.

Other advantages and alternative embodiments of the disclosure are obvious to those skilled in the art. Therefore, the present disclosure in its broader sense is not limited to the specific details, representative structures, and exemplary embodiments shown and described here. On the contrary, those skilled in the art can make various modifications and substitutions without departing from the basic spirit and scope of the present disclosure.

1.-10. (canceled)

11. A power battery system (100) of a vehicle, comprising:
a battery module (10) which comprises a plurality of battery cells (11) and a plurality of busbar assemblies (12);
wherein the plurality of busbar assemblies (12) are configured to connect adjacent battery cells (11);
wherein each of the plurality of busbar assemblies (12) comprises:
a busbar (1);
a flexible circuit board (3) which is integrated with a temperature sensor (4) and outputs a temperature signal detected by the temperature sensor (4);
an inner heat shield insulating layer (2) which is disposed at least between the busbar (1) and the flexible circuit board (3); and
an outer insulating layer (5) which is configured to wrap the busbar (1) and the flexible circuit board (3); and
a controller (20) which is configured to receive a respective temperature signal detected by the temperature sensor (4) of each of the plurality busbar assemblies (12) and to predict a direction of thermal diffusion and/or a breakdown point of the battery module (10) according to the respective temperature signals.

12. The power battery system (100) according to claim 11, wherein the controller (20) is disposed in a battery management system or a body control unit of the vehicle or in a remote server for the vehicle.

13. The power battery system (100) according to claim 11, wherein at least one of the plurality of busbar assemblies (12) further comprises an air pressure sensor (7) which comes into contact with gas in the battery module (10) through an opening (8) in the outer insulating layer (5) and outputs an air pressure signal via the flexible circuit board (3).

14. The power battery system (100) according to claim 13, wherein the controller (20) assesses a degree of thermal diffusion of the battery module (10) and/or an opening state of a pressure relief valve for the battery module (10) according to the air pressure signal.

15. The power battery system (100) according to claim 11, wherein:
the inner heat shield insulating layer (2) is disposed in a form of a layer between the busbar (1) and the flexible circuit board (3); or
the inner heat shield insulating layer (2) wraps the busbar (1) in a form of a sheath.

16. The power battery system (100) according to claim 11, wherein:
the outer insulating layer (5) is a heat shrinkable sleeve; or
the outer insulating layer (5) is constructed as a first outer insulating layer (5.1) and a second outer insulating layer (5.2) separated from each other, wherein the first outer insulating layer (5.1) and the second outer insulating layer (5.2) are fixedly connected to each other in a form-fit manner.

17. The power battery system (100) according to claim 11, wherein:
the outer insulating layer (5) is made of a heat-resistant and fire-resistant material; and/or
the busbar assembly (12) further comprises an additional heat insulating layer (6) disposed between the outer insulating layer (5) and the flexible circuit board (3) or between the outer insulating layer (5) and the busbar (1); and/or
the busbar (1) is made of copper, aluminum, nickel or an alloy thereof.

18. The power battery system (100) according to claim 11, further comprising an interaction unit (30) which displays a temperature distribution inside the battery module (10) in a form of an image and feeds back the direction of thermal diffusion and/or the breakdown point of the battery module (10) predicted by the controller (20).

19. The power battery system (100) according to claim 11, wherein the controller (20) sends the respective temperature signals or the direction of thermal diffusion and/or the breakdown point of the battery module (10) predicted by the controller (20) to an original equipment manufacturer of the vehicle via a real-time monitoring system of the vehicle.

20. A thermal assessment method for a power battery system (100) of a vehicle, comprising the steps of:
S1: detecting temperature signals of a plurality of busbar assemblies (12) of a battery module (10) of the power battery system (100);
S2: determining that the battery module (10) is in a thermal runaway state when the temperature signal of at least one of the plurality of busbar assemblies (12) exceeds a temperature threshold; and
S3: predicting a direction of thermal diffusion and/or a breakdown point of the battery module (10) based on the temperature signals of the plurality of busbar assemblies (12).
